(19) United States
(12) Patent Application Publication
(10) Pub. No.: US 2026/0331793 A1
(43) Pub. Date: Oct. 22, 2026

(54) RUBBER SLEEVE TERMINAL

(71) Applicant: Yueqing Heda Electronic Co., Ltd., Wenzhou (CN)

(72) Inventors: Bohao ZHAO, Wenzhou (CN); Lihua JIN, Wenzhou (CN); Zhijian ZHAO, Wenzhou (CN)

(73) Assignee: Yueqing Heda Electronic Co., Ltd., Wenzhou (CN)

(21) Appl. No.: 19/419,166

(22) Filed: Dec. 15, 2025

(30) Foreign Application Priority Data
Apr. 16, 2025 (CN) 202520720589.6

(51) Int. Cl. H01R 4/70; H01R 4/18

(52) U.S. Cl. CPC H01R 4/70; H01R 4/184

(57) ABSTRACT

Disclosed is a rubber sleeve terminal, including a conductive part, a bottom wall of the conductive part being formed with an elevated surface; an insulating sheath further sleeved on the conductive part, a bottom wall of the insulating sheath being formed with a support surface for contacting glass; the support surface exceeding the elevated surface, the insulating sheath being used for elevating the conductive part; a limiting groove disposed on the conductive part, the insulating sheath being sleeved in the limiting groove, an inner sidewall of the insulating sheath and an inner sidewall of the limiting groove fitting closely with each other, the limiting groove being used for limiting and fixing the insulating sheath on the conductive part. The present disclosure has an effect of being capable of effectively improving a situation where glass ruptures after welding of the terminal is completed, thereby being capable of increasing a yield rate.

### CROSS-REFERENCE TO RELATED APPLICATIONS

The application claims priority to Chinese patent application No. 202520720589.6, filed on Apr. 16, 2025, the entire contents of which are incorporated herein by reference.

### TECHNICAL FIELD

The present disclosure relates to the technical field of wiring terminals, and specifically relates to a rubber sleeve terminal.

### BACKGROUND

Currently, the wiring terminal is an accessory product used for implementing electrical connection, and is widely applied in various electrical equipment and electronic equipment. The wiring terminals are mainly used for connection, disconnection, or branching between conductive wires, making circuit connection more convenient and reliable.

Windshields of most vehicles on the market possess a heating function, aiming to quickly remove frost or fog on the windshields. The heating function needs to be implemented through a conductive material (usually a fine metal wire or a transparent conductive film), and the heating elements need to be connected to an electrical system of the vehicle through the wiring terminals.

In the related art, the wiring terminal on the vehicle glass is usually fixed by using a welding method, but in a welding process, since a support surface of the wiring terminal is in direct contact with a glass surface, a high temperature generated in the welding process will cause the wiring terminal and the glass to undergo thermal expansion, and a difference exists between an expansion coefficient of the wiring terminal and an expansion coefficient of the glass, after cooling, the wiring terminal and the glass will undergo contraction to generate stress, and the wiring terminal is made of a metal rigid material, so the stress cannot be dispersed in time, which finally easily leads to a situation of rupture of the glass after the welding is completed, reducing a yield rate.

### SUMMARY

Provided in the present disclosure is a rubber sleeve terminal, having an effect of being capable of effectively improving a situation where glass ruptures after welding of the terminal is completed, thereby being capable of increasing a yield rate.

The rubber sleeve terminal provided in the present disclosure adopts the following technical solutions:

A rubber sleeve terminal includes a conductive part, a bottom wall of the conductive part formed with an elevated surface, an insulating sheath further sleeved on the conductive part, and a bottom wall of the insulating sheath formed with a support surface for contacting glass; the support surface exceeds the elevated surface, and the insulating sheath is used for elevating the conductive part; a limiting groove is disposed on the conductive part, the insulating sheath is sleeved in the limiting groove, an inner sidewall of the insulating sheath and an inner sidewall of the limiting groove fit closely with each other, and the limiting groove is used for limiting and fixing the insulating sheath on the conductive part.

Optionally, a crimping piece is integrally formed on a sidewall of the conductive part facing away from the elevated surface, the crimping piece is for an electric wire to be inserted on the conductive part, and the crimping piece is used for pressing and fixing the electric wire on the conductive part.

Optionally, the crimping piece is located at a middle position of the conductive part, and the insulating sheath is symmetrically disposed on two sides of the crimping piece.

Optionally, a first bent piece and a second bent piece are formed by bending a metal sheet material for the conductive part, and the insulating sheath is disposed at end portions of the first bent piece and the second bent piece.

Optionally, the first bent piece and the second bent piece are both penetrated with a through hole, the through hole is located at a fitting place of the first bent piece and the second bent piece, and the through holes communicate with each other.

Optionally, the insulating sheath is fixedly sleeved on an outside of the conductive part and the crimping piece.

Optionally, a glue fixing layer is disposed between the inner sidewall of the insulating sheath and an outer sidewall of the crimping piece.

In summary, the present disclosure includes at least one of the following beneficial technical effects:
1. under support of the insulating sheaths on the two sides, the conductive part will maintain an elevated state, and a certain interval will be separated out between the elevated surface and a glass surface, so the elevated surface will not be in direct contact with the glass surface. At this time, stress generated by the conductive part and the glass during a welding process will be dispersed under a circumstance of no support point, thereby being capable of effectively improving the situation where the glass ruptures after welding, and greatly increasing the yield rate;
2. the limiting groove is used for limiting and fixing the insulating sheath on the conductive part, thereby being capable of effectively preventing occurrence of a situation where the insulating sheath detaches from the conductive part under an action of an external force, and ensuring the connection strength of the insulating sheath;
3. by disposing a connection place of the electric wire at the middle position of the conductive part, the stability of force receiving at a welding place of the conductive part can be improved when the electric wire is subjected to pulling of the external force, ensuring uniform force receiving at the welding place, thereby forming a stable mechanical structure, and improving the structural strength of the welding place.

### BRIEF DESCRIPTION OF THE DRAWINGS

FIG. 1 is a schematic diagram of an overall structure of a first example of the present disclosure when connected with an electric wire.

FIG. 2 is an exploded schematic diagram of a partial structure of FIG. 1 from another perspective.

FIG. 3 is a schematic diagram of an overall structure of a second example of the present disclosure.

FIG. 4 is a schematic diagram of a partial structure of FIG. 3 from another perspective.

FIG. 5 is a schematic diagram of an overall structure of a third example of the present disclosure when connected with an electric wire.

Description of reference numerals: 1 conductive part; 10 elevated surface; 100 first bent piece; 101 second bent piece; 102 spacer; 103 through hole; 11 limiting groove; 2 insulating sheath; 20 support surface; 3 crimping piece; 4 glue fixing layer.

### DETAILED DESCRIPTION OF THE EMBODIMENTS

The present disclosure is described in further detail below with reference to the drawings.

The examples of the present disclosure disclose a rubber sleeve terminal.

### Example 1

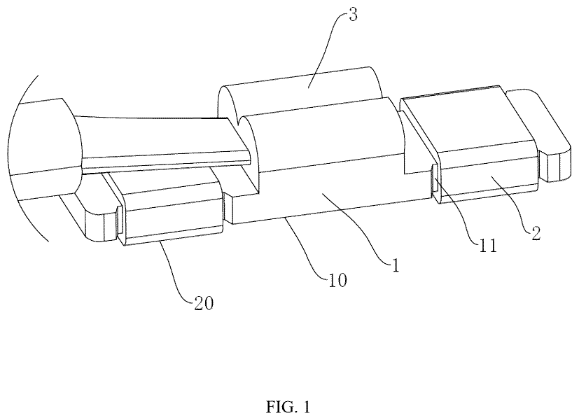

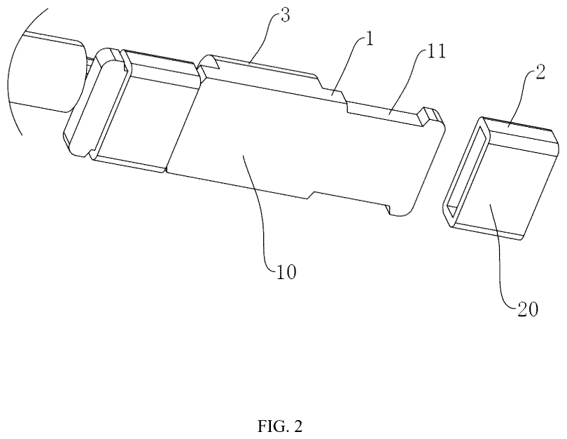

Referring to FIG. 1 and FIG. 2, the rubber sleeve terminal includes a conductive part 1 made of a metal conductive material, the conductive part 1 is in a long strip shape, and a bottom wall of the conductive part 1 is formed with an elevated surface 10. Two insulating sheaths 2 made of a non-metal material are further sleeved on the conductive part 1, and in the example, a material quality of the insulating sheath 2 can adopt plastic or rubber having a certain elastic deformation ability, and the insulating sheaths 2 are symmetrically disposed at left and right ends of the conductive part 1.

As shown in FIG. 1 and FIG. 2, a bottom wall of the insulating sheath 2 is formed with a support surface 20 for contacting a glass surface, the support surface 20 exceeds the elevated surface 10, and by placing the insulating sheath 2 on the glass surface, at this time, under support of the insulating sheaths 2 on two sides, the conductive part 1 will maintain an elevated state, a certain interval will be separated out between the elevated surface 10 and the glass surface, so the elevated surface 10 will not be in direct contact with the glass surface. Stress generated by the conductive part 1 and glass during a welding process will be dispersed under a circumstance of no support point, thereby being capable of effectively improving a situation where the glass ruptures after welding, and greatly increasing a yield rate.

As shown in FIG. 1 and FIG. 2, a limiting groove 11 is further disposed on the conductive part 1, and the insulating sheaths 2 are respectively sleeved in the corresponding limiting grooves 11. An inner sidewall of the insulating sheath 2 and an inner sidewall of the limiting groove 11 fit closely with each other, and the limiting groove 11 is used for limiting and fixing the insulating sheath 2 on the conductive part 1, thereby being capable of effectively preventing occurrence of a situation where the insulating sheath 2 detaches from the conductive part 1 under an action of an external force, and ensuring connection strength of the insulating sheath 2.

As shown in FIG. 1 and FIG. 2, a crimping piece 3 is integrally formed on a sidewall of the conductive part 1 facing away from the elevated surface 10, the crimping piece 3 is for an electric wire to be inserted on the conductive part 1, and the crimping piece 3 is used for pressing and fixing the electric wire on the conductive part 1. In addition, the electric wire can further be directly fixed on the crimping piece 3 by welding, the crimping piece 3 is located at a middle position of the conductive part 1, and the insulating sheaths 2 are symmetrically disposed on two sides of the crimping piece 3. By disposing a connection place of the electric wire at the middle position of the conductive part 1, stability of force receiving at a welding place of the conductive part 1 can be improved when the electric wire is subjected to pulling of the external force, ensuring that force receiving at the welding place is more uniform, thereby forming a stable mechanical structure, and improving structural strength of the welding place.

### Example 2

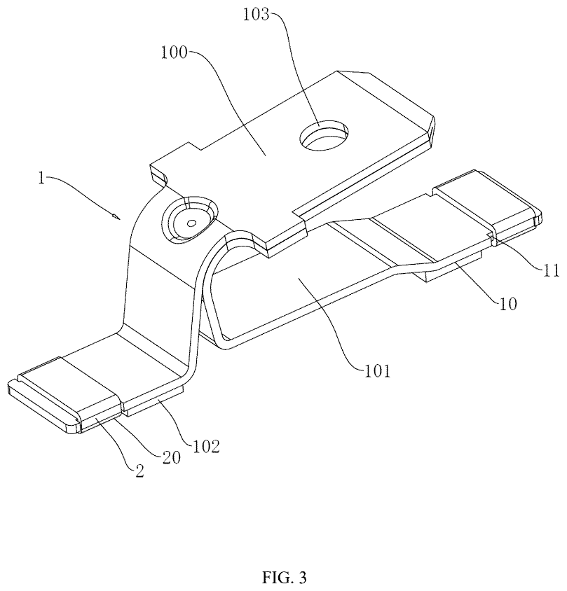

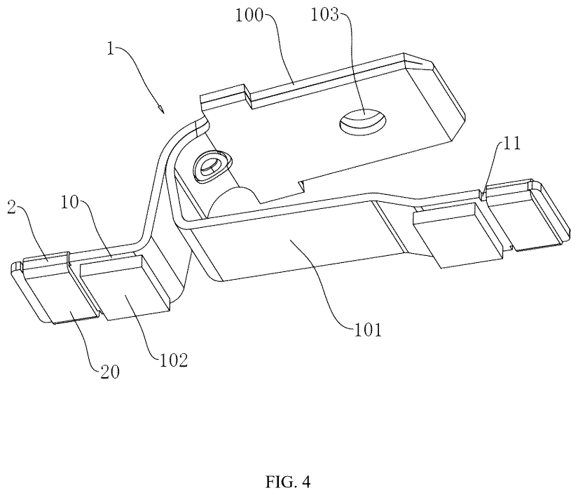

As shown in FIG. 3 and FIG. 4, different from the structure of Example 1, a first bent piece 100 and a second bent piece 101 are formed by bending a section of metal sheet material for the conductive part 1, and the insulating sheaths 2 are respectively disposed at end portions of the first bent piece 100 and the second bent piece 101. A spacer 102 is disposed on the elevated surfaces 10 of both the first bent piece 100 and the second bent piece 101, and the spacer 102 can similarly be used for elevating the conductive part 1. A through hole 103 penetrates both the first bent piece 100 and the second bent piece 101, the through hole 103 is located at a fitting place of the first bent piece 100 and the second bent piece 101, and the through holes 103 communicate with each other. The through hole 103 can be for the electric wire to be wound and fixed on the conductive part 1.

### Example 3

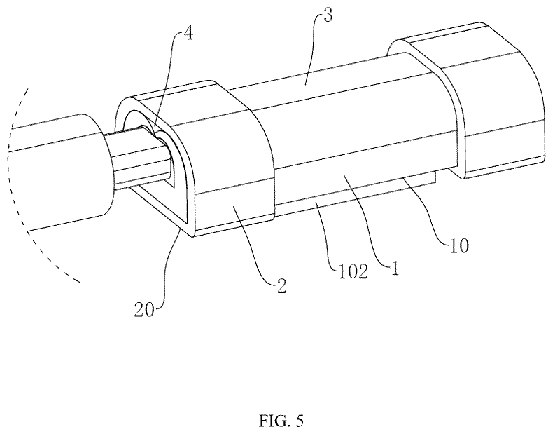

As shown in FIG. 5, different from the structure of Example 1, the insulating sheath 2 is fixedly sleeved on an outside of the conductive part 1 and the crimping piece 3, and the bottom wall of the insulating sheath 2 is similarly used for elevating the elevated surface 10 of the conductive part 1, making a certain interval separated out between the elevated surface 10 and the glass surface, and ensuring the elevated surface 10 will not be in direct contact with the glass surface. A glue fixing layer 4 is disposed between the inner sidewall of the insulating sheath 2 and an outer sidewall of the crimping piece 3, and the glue fixing layer 4 is formed after coating and solidifying glue. The glue fixing layer 4 can further enhance connection strength of the conductive part 1, the insulating sheath 2, and the crimping piece 3, and further improve connection reliability. The spacer 102 is similarly disposed on the elevated surface 10 located at a bottom of the conductive part 1, and the spacer 102 can further elevate the elevated surface 10.

An implementation principle is as follows: under support of the insulating sheaths 2 on the two sides, the conductive part 1 will maintain the elevated state, and a certain interval will be separated out between the elevated surface 10 and the glass surface, so the elevated surface 10 will not be in direct contact with the glass surface. Stress generated by the conductive part 1 and the glass during the welding process will be dispersed under the circumstance of no support point, thereby being capable of effectively improving the situation where the glass ruptures after welding, and greatly increasing the yield rate. The limiting groove 11 is used for limiting and fixing the insulating sheath 2 on the conductive part 1, thereby being capable of effectively preventing occurrence of the situation where the insulating sheath 2 detaches from the conductive part 1 under the action of the external force, and ensuring the connection strength of the insulating sheath 2.

By disposing the connection place of the electric wire at the middle position of the conductive part 1, the stability of force receiving at the welding place of the conductive part 1 can be improved when the electric wire is subjected to pulling of the external force, ensuring that the force receiving at the welding place is more uniform, thereby forming the stable mechanical structure, and improving the structural strength of the welding place.

The above are all preferred examples of the present disclosure, and are not intended to limit a protection scope of the present disclosure, therefore: all equivalent changes made according to the structure, shape, and principle of the present disclosure should be covered within the protection scope of the present disclosure.

What is claimed is:

1. A rubber sleeve terminal, comprising a conductive part 1, wherein a bottom wall of the conductive part 1 is formed with an elevated surface 10, an insulating sheath 2 is further sleeved on the conductive part 1, and a bottom wall of the insulating sheath 2 is formed with a support surface 20 for contacting glass; the support surface 20 exceeds the elevated surface 10, and the insulating sheath 2 is used for elevating the conductive part 1; and a limiting groove 11 is disposed on the conductive part 1, the insulating sheath 2 is sleeved in the limiting groove 11, an inner sidewall of the insulating sheath 2 and an inner sidewall of the limiting groove 11 fit closely with each other, and the limiting groove 11 is used for limiting and fixing the insulating sheath 2 on the conductive part 1.

2. The rubber sleeve terminal according to claim 1, wherein a crimping piece 3 is integrally formed on a sidewall of the conductive part 1 facing away from the elevated surface 10, the crimping piece 3 is for an electric wire to be inserted on the conductive part 1, and the crimping piece 3 is used for pressing and fixing the electric wire on the conductive part 1.

3. The rubber sleeve terminal according to claim 2, wherein the crimping piece 3 is located at a middle position of the conductive part 1, and the insulating sheath 2 is symmetrically disposed on two sides of the crimping piece 3.

4. The rubber sleeve terminal according to claim 1, wherein a first bent piece 100 and a second bent piece 101 are formed by bending a metal sheet material for the conductive part 1, and the insulating sheath 2 is disposed at end portions of the first bent piece 100 and the second bent piece 101.

5. The rubber sleeve terminal according to claim 4, wherein the first bent piece 100 and the second bent piece 101 are both penetrated with a through hole 103, the through hole 103 is located at a fitting place of the first bent piece 100 and the second bent piece 101, and the through holes 103 communicate with each other.

6. The rubber sleeve terminal according to claim 2, wherein the insulating sheath 2 is fixedly sleeved on an outside of the conductive part 1 and the crimping piece 3.

7. The rubber sleeve terminal according to claim 6, wherein a glue fixing layer 4 is disposed between an inner sidewall of the insulating sheath 2 and an outer sidewall of the crimping piece 3.
